(19) United States
(12) Patent Application Publication
(10) Pub. No.: US 2026/0051907 A1
(43) Pub. Date: Feb. 19, 2026

(54) COMMUNICATION DEVICE AND OPERATION METHOD THEREOF FOR ENHANCING FIRST PATH DYNAMIC RANGE

(71) Applicant: Realtek Semiconductor Corp., HsinChu (TW)

(72) Inventors: Ran Zhang, Suzhou City (CN); Mingzhi Guo, Suzhou City (CN)

(73) Assignee: Realtek Semiconductor Corp., HsinChu (TW)

(21) Appl. No.: 19/235,634

(22) Filed: Jun. 12, 2025

(30) Foreign Application Priority Data
Aug. 15, 2024 (CN) 202411120176.0

(51) Int. Cl. H04B 1/00; H04B 1/04; H04W 72/044

(52) U.S. Cl. CPC H04B 1/0078; H04B 1/0483; H04W 72/0466; H04B 2001/0408

(57) ABSTRACT

A method of operating a communication device includes amplifying a preset proportion of symbols in a set of input symbols to generate a set of amplified symbols, accumulating the set of amplified symbols to generate an enhanced symbol, searching for a first path according to the enhanced symbol, accumulating unamplified symbols in the set of input symbols to generate an normal symbol, and searching for the first path according to the normal symbol. The method further includes generating a first path signal if the first path is found according to the enhanced symbol and/or the normal symbol, and generating a first path dynamic range (FPDR) according to at least the first path signal.

### BACKGROUND OF THE INVENTION

### 1. Field of the Invention

The invention relates to communication systems, and in particular, to a communication device and operation method thereof for enhancing first path dynamic range in an ultra wideband (UWB) system.

### 2. Description of the Prior Art

Ultra wideband (UWB) is a radio frequency technology that operates in a wider frequency range, typically between 3.1 GHz and 10.6 GHz, to achieve high data rates and precise ranging and positioning functions. UWB systems are characterized by the transmission of extremely short-duration pulses, usually in the range of nanoseconds or less while occupying a large bandwidth. The UWB systems are widely used in the fields of wireless personal area network (WPAN), positioning, radar, military and security.

A UWB system estimates the first path dynamic range (FPDR) to achieve high-precision ranging and positioning applications. However, the current UWB system cannot improve the first path dynamic range, resulting in limited ranging and positioning applications.

### SUMMARY OF THE INVENTION

According to an embodiment of the invention, a communication device includes an analog-to-digital converter, a symbol accumulator, an enhanced first path searcher, a normal first path searcher, a selector, and a first path dynamic range generator. The analog-to-digital converter is used to amplify a preset proportion of symbols in a set of input symbols to generate a set of amplified symbols. The symbol accumulator is coupled to the analog-to-digital converter, and is used to accumulate the set of amplified symbols to generate an enhanced symbol, and to accumulate unamplified symbols in the set of input symbols to generate a normal symbol. The enhanced first path searcher is coupled to the symbol accumulator, and is used to search for a first path according to the enhanced symbol. The normal first path searcher is coupled to the symbol accumulator, and is used to search for the first path according to the normal symbol. The selector is coupled to the enhanced first path searcher and the normal first path searcher, and is used to generate a first path signal if the enhanced first path searcher and/or the normal first path searcher find the first path. The first path dynamic range generator is coupled to the selector and is used to generate a first path dynamic range according to at least the first path signal.

According to another embodiment of the invention, a communication device includes an analog-to-digital converter, a symbol accumulator, a first path searcher, and a first path dynamic range generator. The analog-to-digital converter is used to amplify a preset proportion of symbols in a set of input symbols to generate a set of amplified symbols. The symbol accumulator is coupled to the analog-to-digital converter, and is used to accumulate the set of amplified symbols to generate an accumulated symbol. The first path searcher is coupled to the symbol accumulator, and is used to search for a first path according to the accumulated symbol to generate a first path signal. The first path dynamic range generator is coupled to the first path searcher and is used to generate a first path dynamic range according to at least the first path signal. The preset proportion is less than ½.

According to another embodiment of the invention, a method of operating a communication device includes amplifying a preset proportion of symbols in a set of input symbols to generate a set of amplified symbols, accumulating the set of amplified symbols to generate an enhanced symbol, searching for a first path according to the enhanced symbol, accumulating unamplified symbols in the set of input symbols to generate an normal symbol, and searching for the first path according to the normal symbol. The method further includes generating a first path signal if the first path is found according to the enhanced symbol and/or the normal symbol, and generating a first path dynamic range (FPDR) according to at least the first path signal.

These and other objectives of the invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of an ultra-wideband system according to an embodiment of the invention.

FIG. 2 is a waveform of the signal received by the communication device in FIG. 1.

FIG. 3 is a block diagram of the communication device in FIG. 1.

FIG. 4 is a flowchart of operating the communication device in FIG. 3.

FIG. 5 is a schematic diagram of the analog-to-digital converter in FIG. 3 generating a set of amplified symbols.

FIG. 6 is a schematic diagram of an ultra-wideband system according to another embodiment of the invention.

### DETAILED DESCRIPTION

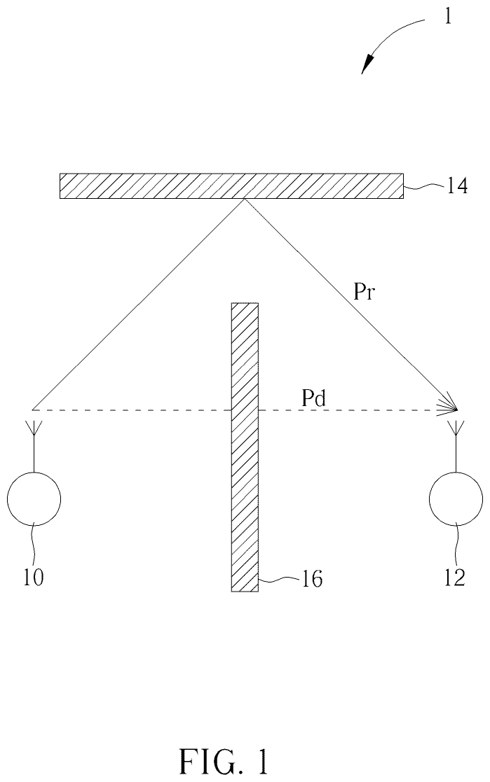

FIG. 1 is a schematic diagram of an ultra-wideband (UWB) system 1 according to an embodiment of the invention. The UWB system 1 may include communication devices 10 and 12 which communicate with each other using UWB technology. In the UWB system 1, the communication device 10 may send UWB signals (pulses) to the communication device 12 in a sporadic and sparse manner.

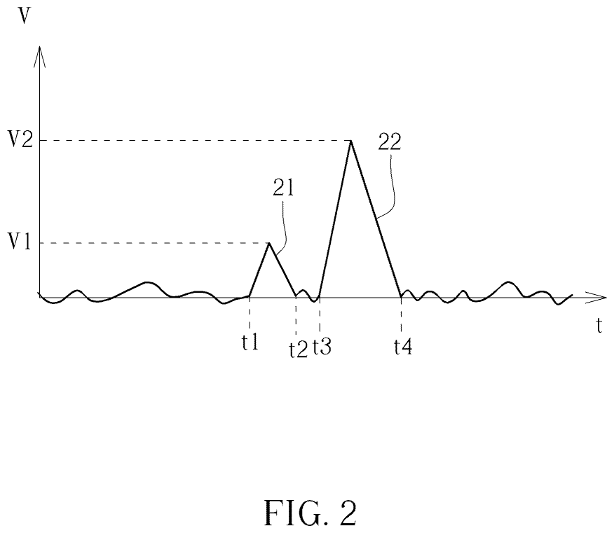

The UWB pulse may be transmitted via a direct path Pd and a reflected path Pr. The direct path Pd represents the route where the UWB pulses travel directly through an obstacle 16 to reach the communication device 12, while the reflected path Pr represents the route where the UWB pulses reflect off the surface of an obstacle 14 to reach the communication device 12. Thus, the signal received by the communication device 12 may include a first path component from the direct path Pd and a main path component from the reflected path Pr, as illustrated in FIG. 2. FIG. 2 is a waveform of the signal received by the communication device 12, with the horizontal axis representing time t and the vertical axis representing the received signal in voltage V. Between Time t1 and Time t2, the first path component 21 appears in the received signal, corresponding to the direct path Pd. Between Time t3 and Time t4, the main path component 22 appears in the received signal, corresponding to the reflected path Pr. Since the direct path Pd is shorter than the reflected path Pr, the first path component 21 occurs earlier than the main path component 22 in the received signal. If the reflected path Pr is significant longer than the direct path Pd, the first path component 21 and the main path component 22 may be separated by a time interval (t2, t3). In some embodiments, if the length of the reflected path Pr approaches the length of the direct path Pd, the time interval between the first path component 21 and the main path component 22 may decreases, sometimes resulting in the first path component 21 and the main path component 22 to overlap. Moreover, the UWB pulse is significantly attenuated when passing through the obstacle 16 but only slightly attenuated after reflected off from the surface of the obstacle 14. Consequently, the peak V1 of the first path component 21 may be lower than the peak V2 of the main path component 22.

Since the first path component 21 corresponds to the direct path Pd, the communication device 12 may detect the first path component 21 from the received signal, so as to estimate the time-of-flight (ToF), the time-of-arrival (ToA), the distance between the communication devices 10 and 12, and other location information. The received signal is an analog signal. During analog-to-digital conversion, the communication device 12 may convert the peak V2 of the main path component 22 into the maximum quantization level of the analog-to-digital converter (ADC). Consequently, the equivalent quantization bit width of the main path component 22 is the ADC resolution. For example, if the ADC resolution is 7 bits, the equivalent quantization bit width of the main path component 22 may also be 7 bits. If the peak V1 of the first path component 21 is significantly less than the peak V2 of the main path component 22, the equivalent quantization bit width of the first path component 21 may fall below the minimum quantization level of the ADC, preventing the communication device 12 from detecting the first path component 21. The capability of the communication device 12 to detect a weak first path component 21 is known as the first path dynamic range (FPDR), measured in decibels (dB). A higher first path dynamic range indicates that the communication device 12 can detect smaller, weaker first path components 21, enhancing the capability to capture weak signals. The communication device 12 may perform channel impulse response (CIR) estimation to compute the first path dynamic range.

While FIG. 1 only shows two transmission paths, the UWB pulse may propagate via other paths. In such cases, the received signal will include the first path component and multiple path components, with the largest peak among the reflected path components designated as the main path component.

The received signal y(t) in FIG. 2 is a time domain signal, expressed by Equation(1):

y(t)=Kx(t)+x(t−τ)+n Equation(1)

where Kx(t) is the first path component;
x(t−τ) is the main path component;
n is the noise;
t is time;
τ is the time delay of the main path component relative to the first path component; and
K is the magnitude of the first path component.

The communication device 12 may adjust the automatic gain control (AGC) setting according to the main path component x(t−τ), setting the equivalent quantization bit width of this main path component to the ADC resolution M. Since the AGC setting is fixed and the magnitude of the first path component Kx(t) is K times that of the main path component x(t−τ), the equivalent quantization bit width of the first path component Kx(t) may be (M+log₂K). The equivalent quantization bit width (M+log₂K) of the first path component Kx(t) must exceed the minimum effective detection bit p, for the communication device 12 to identify the first path component Kx(t), as shown in Equation (2).

M+log2K≥p Equation (2)

The minimum effective detection bit p is a constant between 0 and 1, determined by the channel impulse response (CIR) estimation and the noise floor of the ADC. In general, a lower noise floor of the ADC results in a minimum effective detection bit p closer to 0. Rearranging Equation (2) into the form −log₂K≤M−p and applying 20log₁₀ to both sides yields the power difference between the main path component x(t−τ) and the first path component Kx(t), known as the first path dynamic range (FPDR), as shown in Equation (3)

FPDR=−20log10(K)≤20log10(2M−p)=6.02(M−p) Equation (3)

According to Equation (3), the first path dynamic range FPDR may be determined by the equivalent quantization bit width M of the main path component x(t−τ) and the minimum effective detection bit p. Since the equivalent quantization bit width M equals the ADC resolution, and the minimum effective detection bit p is close to 1, reducing p would be challenging, posing difficulty to increase the first path dynamic range FPDR. For example, if M=7 and p=1, the first path dynamic range FPDR of the communication device 12 will be substantially fixed at 36 dB (=6.02(7−1)).

If the ADC further amplifies the received signal y(t) by an AGC circuit to raise the equivalent quantization bit widths of both the first path component Kx(t) and the main path component x(t−τ) by N bits, the amplified equivalent quantization bit width for the first path component Kx(t) becomes (M+N+log₂K), and for the main path component x(t−τ) the amplified equivalent quantization bit width becomes (M+N). Since the amplified equivalent quantization bit width (M+N) of the main path component x(t−τ) exceeds the ADC resolution M, clipping occurs, introducing a clipping noise f(N), and updating the minimum effective detection bit from p to (p+f(N)). The amplified equivalent quantization bit width (M+N+log₂K) of the first path component Kx(t) must exceed the updated minimum effective detection bit (p+f(N)), for the communication device 12 to identify the first path component Kx(t), as expressed by Equation (4):

M+N+log2k≥p+f(N) Equation (4)

Rearrange Equation (4) into the form −log₂K≤M+Npf(N) and applying 20log₁₀ to both sides to yield the first path dynamic range FPDR, as expressed in Equation (5):

FPDR=−20log10(K)≤20log10(2M+N−p−f(N))=6.02(M+N−p−f(N)) Equation (5)

According to Equation (5), the first path dynamic range FPDR may be determined by the ADC resolution M, the equivalent raising bits N, the minimum effective detection bit p, and the clipping noise f(N). Since the ADC resolution M and the minimum effective detection bit p remain unchanged, and the equivalent raising bits N exceeds the clipping noise f(N), the first path dynamic range FPDR is enhanced. For example, if M=7, N=1, p=1, and f(N)=0.35, the first path dynamic range FPDR of the communication device 12 is substantially 40 dB (=6.02(7+1−1−0.35)). Comparatively, the first path dynamic range FPDR of the amplified received signal y(t) is enhanced by 4 dB (=40−36) over the unamplified received signal y(t). In another instance, if M=7, N=2, p=1, and f(N)=1, the first path dynamic range FPDR of the communication device 12 is substantially 42 dB (=6.02(7+2−1−1)). Comparatively, the first path dynamic range FPDR of the amplified received signal y(t) is enhanced by 6 dB (=42−36) over the unamplified received signal y(t).

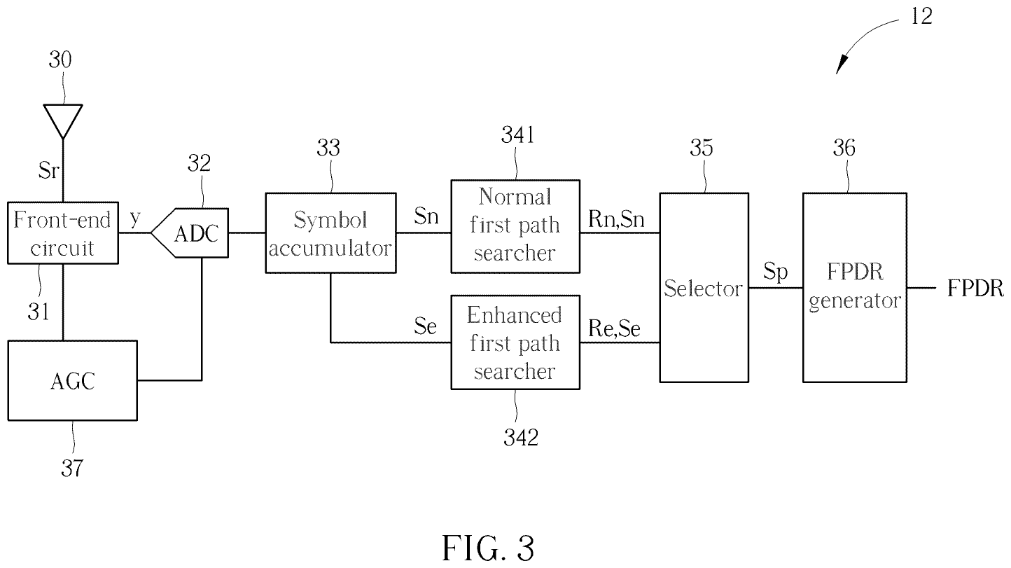

FIG. 3 is a block diagram of the communication device 12. The communication device 12 includes an antenna 30, a front-end circuit 31, an ADC 32, an AGC circuit 37, a symbol accumulator 33, a normal first path searcher 341, an enhanced first path searcher 342, a selector 35 and an FPDR generator 36. The antenna 30, the front-end circuit 31, the ADC 32, and the symbol accumulator 33 may be coupled in sequence. The AGC circuit 37 may be coupled to the ADC 32, and the front-end circuit 31 may be coupled to the AGC circuit 37. The normal first path searcher 341 and the enhanced first path searcher 342 may be coupled to the symbol accumulator 33. The selector 35 may be coupled to the normal first path searcher 341 and the enhanced first path searcher 342. The FPDR generator 36 may be coupled to the selector 35.

The antenna 30 may receive the UWB pulses to generate the signal Sr. The front-end circuit 31 may amplify, filter, and perform other signal processing on the signal Sr to generate the received signal y. The received signal y may include a frame, and the frame may include a synchronization sequence, a start frame delimiter (SFD), a scrambled timestamp sequence (STS), and payload data, where the synchronization sequence and frame start delimiter may form a preamble. The ADC 32 may convert the received signal y from analog to digital, generating a plurality of bits in the frame. Each bit may include a set of input symbols, with each set of input symbols containing Q input symbols, where Q is an integer greater than 1, such as Q=8. Each input symbol may contain a first path component and a main path component. The AGC circuit 37 may adjust the AGC setting according to the main path component 22 and subsequently modify the gain (e.g., amplifier gain) of the front-end circuit 31 accordingly, ensuring that the equivalent quantization bit width of the main path component 22 matches the ADC resolution M (e.g., M=7).

The AGC circuit 37 may adjust the AGC setting to allow the front-end circuit 31 to amplify the preamble and/or STS code, enabling the ADC 32 to amplify a preset proportion of input symbols to generate a set of amplified symbols. Each amplified symbol in the set of amplified symbols includes the first path component having a quantization bit width of (M+N+log₂K), and the main path component having a quantization bit width of (M+N). The set of amplified symbols may have a repeating symbol structure, such as the preamble in the UWB system. In some embodiments, the set of amplified symbols may exclude the scrambled timestamp sequence (STS) of the UWB system. The preset ratio may be less than ½ to preserve complete information for at least half of the main path components for later processing. For example, with a preset ratio of 0.25, M=7, and N=1, the ADC 32 amplifies 2 out of 8 input symbols in the preamble or STS code without amplifying the remaining 6 input symbols to generate a set of amplified symbols. For each amplified symbol, the quantization bit width of the first path component becomes (8+log₂K), while for each unamplified symbol, the quantization bit width of the first path component remains (7+log₂K).

The symbol accumulator 33 may accumulate the amplified symbols to generate an enhanced symbol Se, and accumulate the unamplified symbols to generate a normal symbol Sn. The normal first path searcher 341 may search for the first path according to the normal symbol Sn. The enhanced first path searcher 342 may search for the first path according to the enhanced symbol Se. The normal first path searcher 341 and the enhanced first path searcher 342 may be correlators. In some embodiments, the normal first path searcher 341 may correlate the normal symbol Sn with a predetermined symbol to detect multiple pulses corresponding to multipaths, thereby generating a search result Rn. The predetermined symbol may be the sum of a known sequence in the preamble or STS code. The first path may correspond to the earliest pulse in the multiple pulses of the multipaths. If the normal symbol Sn successfully matches the predetermined symbol, the normal first path searcher 341 may indicate in the search result Rn that the first path and/or other paths have been found. If the normal symbol Sn fails to match the predetermined symbol, the normal first path searcher 341 may indicate in the search result Rn that no path is found. Similarly, the enhanced first path searcher 342 may correlate the enhanced symbol Se and the predetermined symbol to detect multiple pulses corresponding to the multipaths, thereby generating a search result Re.

If the normal first path searcher 341 and/or the enhanced first path searcher 342 finds the first path, the selector 35 may generate the first path signal Sp. The selector 35 may independently determine if the normal first path searcher 341 has found the first path according to the search result Rn, or if the enhanced first path searcher 342 has found the first path according to the search result Re. In some embodiments, if the search result Re indicates that the enhanced first path searcher 342 finds the first path and the search result Rn indicates that the normal first path searcher 341 does not, the selector 35 may generate the first path signal Sp according to the enhanced symbol Se. In some embodiments, the selector 35 may directly output the enhancement symbol Se as the first path signal Sp. If the search result Re and the search result Rn indicate that both the enhanced first path searcher 342 and the normal first path searcher 341 find the first path, the selector 35 may generate the first path signal Sp according to the enhanced symbol Se. In some embodiments, the selector 35 may directly output the enhancement symbol Se as the first path signal Sp. If the search result Re indicates that the search result Rn indicates that the normal first path searcher 341 finds the first path and the enhanced first path searcher 342 does not, the selector 35 may generate the first path signal Sp according to the normal symbol Sn. In some embodiments, the selector 35 may directly output the normal symbol Sn as the first path signal Sp. If the search result Re and the search result Rn indicate that both the enhanced first path searcher 342 and the normal first path searcher 341 has not found the first path, the selector 35 may be prevented from generating the first path signal Sp. In some embodiments, the selector 35 may include a multiplexer and a selection logic. The selection logic may select the multiplexer to output the normal symbol Sn or the enhanced symbol Se as the first path signal Sp according to the search result Re and the search result Rn.

The FPDR generator 36 may at least generate a first path dynamic range FPDR according to the first path signal Sp. In some embodiments, the FPDR generator 36 may generate the first path dynamic range FPDR according to the actual equivalent quantization bit width Sbw of the first path signal Sp, the resolution M of the ADC 32, the raising bits N of the set of amplified symbols, and the clipping noise f(N), as expressed by Equation (6):

FPDR=6.02(M+N−Sbw−f(N)) Equation (6)

Equation (6) is similar to Equation (5), but Equation (6) uses the actual equivalent quantized bit width Sbw of the first path signal Sp instead of the minimum effective detection bit p in Equation (5). The actual equivalent quantized bit width Sbw of the first path signal Sp exceeds or is equal to the minimum effective detection bit p. For example, with M=7, N=2, Sp=2, f(N)=1, the first path dynamic range FPDR of the communication device 12 is substantially 36 dB (=6.02(7+2−2−1)).

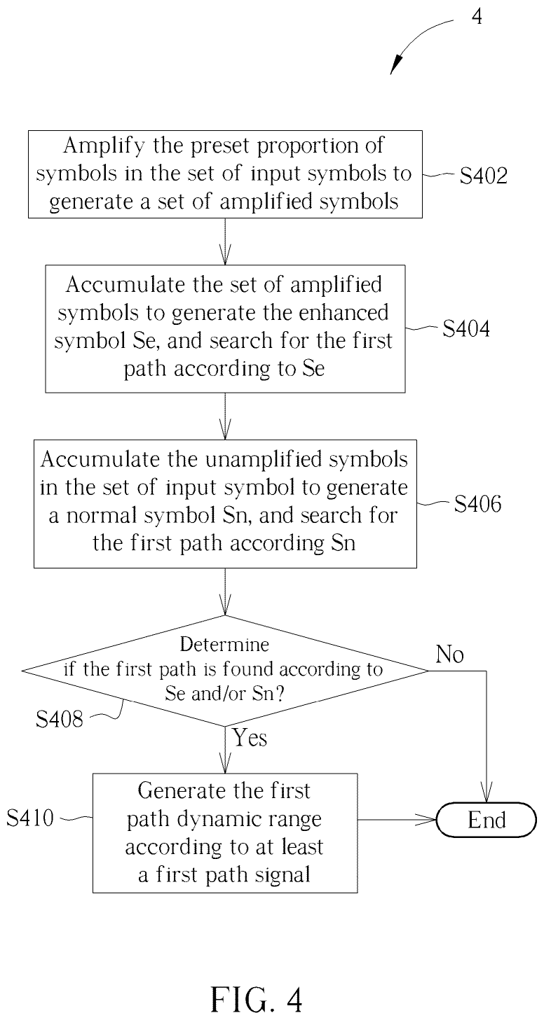

FIG. 4 is a flowchart of a method 4 of operating the communication device 12. The method 4 include Steps S402 to S410 to enhance the first path dynamic range FPDR. Any reasonable step change or adjustment is within the scope of the disclosure. Steps S402 to S410 are detailed as follows:
Step S402: The ADC 32 amplifies the preset proportion of symbols in the set of input symbols to generate a set of amplified symbols;
Step S404: The symbol accumulator 33 accumulates the set of amplified symbols to generate the enhanced symbol Se, and the enhanced first path searcher 342 searches for the first path according to the enhanced symbol Se;
Step S406: The symbol accumulator 33 accumulates the unamplified symbols in the set of input symbol to generate a normal symbol Sn, and the normal first path searcher 341 searches for the first path according to the normal symbol Sn;
Step S408: The selector 35 determines if the first path is found according to the enhanced symbol Se and/or the normal symbols Sn? If so, proceed to Step S410; if not, terminate Method 4.
Step S410: The FPDR generator 36 generates the first path dynamic range FPDR according to at least the first path signal Sp; terminate Method 4.

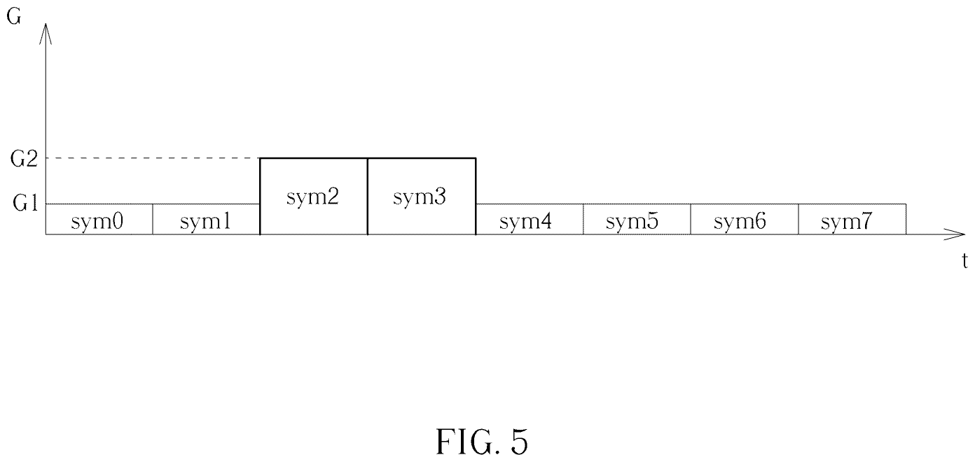

The method 4 is explained with reference to FIGS. 3 to 5. FIG. 5 is a schematic diagram of the ADC 32 generating a set of amplified symbols, where the horizontal axis represents time t and the vertical axis represents gain G. FIG. 5 shows a set of input symbols including symbols sym0 to sym7. The symbols sym0 to sym7 may be preamble or STS symbols. The preset ratio may be 25%. The AGC circuit 37 adjusts the AGC setting for the front-end circuit 31 to amplify a portion of the signal Sr (including the preamble and/or STS code), allowing the ADC 32 to amplify the symbols sym2 and sym3 according to a gain, and does not amplify the symbols sym0, sym1, sym4 to sym7. The gain for the symbols sym2 and sym3 may be G2, and the gain for the symbols sym0, sym1, sym4 to sym7 may be G1, with G2 being greater than G1 (Step S402).

In some embodiments, the set of amplified symbols may be consecutive symbols in the set of input symbols, such as symbols sym2 and sym3, facilitating to stabilize the AGC circuit 37 and the front-end circuit 31. In other embodiments, the set of amplified symbols may be non-consecutive symbols in the set of input symbols, such as the symbols sym0 and sym3.

In Step S404, the symbol accumulator 33 accumulates the amplified symbols sym2 and sym3 to generate the enhanced symbol Se, and the enhanced first path searcher 342 searches for the first path according to the enhanced symbol Se to generate a search result Re. In Step S406, the symbol accumulator 33 accumulates the original symbols sym0, sym1, sym4 to sym7 to generate the normal symbol Sn, and the normal first path searcher 341 searches for the first path according to the normal symbol Sn to generate a search result Rn. Step S404 and step S406 may be executed in parallel or sequentially. In Step S408, the selector 35 uses the search results Re and Rn to determine if the first path is found according to the enhanced symbol Se and/or the normal symbol Sn. If the first path is found, the selector 35 generates the first path signal Sp. The FPDR generator 36 then uses the first path signal Sp to generate the first path dynamic range FPDR (Step S410), and Method 4 is terminated. If the first path cannot be found, Method 4 is terminated. The method by which the selector 35 generates the first path signal Sp and the FPDR generator 36 generates the first path dynamic range FPDR has been explained above and will not be repeated here.

In some embodiments, the first path component may be superimposed on the main path component. In such cases, if the gain of the amplified symbol is too large, the first path component may be set to the clipping zone and discarded. To avoid discarding the first path component, the spreading factor L of the UWB signal may be increased. The unit of the spreading factor L may be equal to the pulse width Tp of the UWB pulse, for example, 2 nanoseconds (ns). For example, increasing the spreading factor L to 128 units extends the spacing between adjacent UWB pulses to 256 ns, thereby reducing the likelihood of discarding the first path component due to overlap with the main path component.

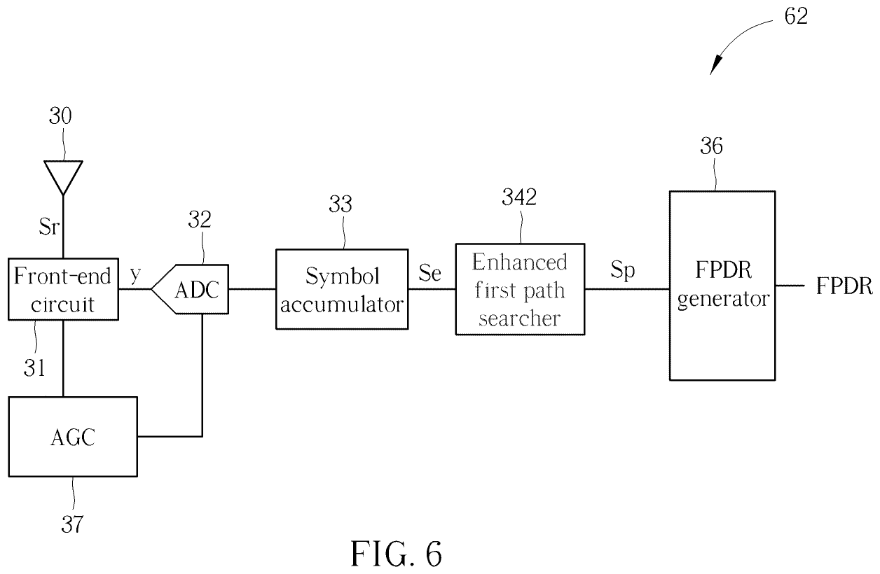

FIG. 6 is a block diagram of a communication device 62 according to an embodiment of the invention. The communication device 62 in FIG. 6 may be configured to replace the communication device 12 in FIG. 3 to generate the first path dynamic range FPDR. Compared with FIG. 3, the communication device 62 in FIG. 6 lacks the normal first path searcher 341 and the selector 35. The operation and configuration of other components in the communication device 62 are similar to those in the communication device 12 in FIG. 3, and thus the explanation therefor will not be repeated here. The communication device 62 generates the first path signal Sp according solely to the first path search result from the enhanced first path searcher 342. Therefore, the normal first path searcher 341 and the selector 35 are not needed, reducing the circuit area and manufacturing cost. Subsequently, the enhanced symbol Se is used to detect the first path, thereby enhancing the first path dynamic range FPDR. The communication device 62 adopts a more radical AGC adjustment strategy. For a line of sight (LOS) scenario (i.e., no first path) in the UWB system, this approach will result in clipping, affecting the accuracy of main path estimation. In some embodiments, for a non-line of sight (NLOS) scenario in the UWB system (i.e., the first path exists), the communication device 62 may be used if the weakest path scenario exists and needs to be detected.

The embodiments in FIGS. 1 to 6 disclose communication devices and operating methods thereof detecting first path signals according to a set of amplified symbols, thereby enhancing the first path dynamic range FPDR.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A communication device comprising:
an analog-to-digital converter configured to amplify a preset proportion of symbols in a set of input symbols to generate a set of amplified symbols;
a symbol accumulator coupled to the analog-to-digital converter, and configured to accumulate the set of amplified symbols to generate an enhanced symbol, and accumulate unamplified symbols in the set of input symbols to generate a normal symbol;
an enhanced first path searcher coupled to the symbol accumulator, and configured to search for a first path according to the enhanced symbol;
a normal first path searcher coupled to the symbol accumulator, and configured to search for the first path according to the normal symbol;
a selector coupled to the enhanced first path searcher and the normal first path searcher, and configured to generate a first path signal if the enhanced first path searcher and/or the normal first path searcher find the first path; and
a first path dynamic range generator coupled to the selector and configured to generate a first path dynamic range (FPDR) according to at least the first path signal.

2. The communication device of claim 1, wherein:
if the enhanced first path searcher finds the first path and the normal first path searcher does not, the selector generates the first path signal according to the enhanced symbol.

3. The communication device of claim 1, wherein:
if both the enhanced first path searcher and the normal first path searcher find the first path, the selector generates the first path signal according to the enhanced symbol.

4. The communication device of claim 1, wherein:
if the normal first path searcher finds the first path and the enhanced first path searcher does not, the selector generates the first path signal according to the normal symbol.

5. The communication device of claim 1, wherein the preset proportion is less than ½.

6. The communication device of claim 1, wherein the first path dynamic range generator generates the first path dynamic range according to the first path signal, a resolution of the analog-to-digital converter, a gain of the set of amplified symbols, and a clipping noise.

7. The communication device of claim 1, wherein the amplifier amplifies a preset proportion of consecutive symbols in the set of input symbols to generate the set of amplified symbols.

8. The communication device of claim 1, wherein the analog-to-digital converter further converts a received signal from analog to digital to generate the set of amplified symbols.

9. The communication device of claim 1, wherein the set of input symbols includes preamble symbols and/or scrambled timestamp sequence (STS) symbols.

10. A communication device comprising:
an analog-to-digital converter configured to amplify a preset proportion of symbols in a set of input symbols to generate a set of amplified symbols;
a symbol accumulator coupled to the analog-to-digital converter, and configured to accumulate the set of amplified symbols to generate an accumulated symbol;
a first path searcher coupled to the symbol accumulator, and configured to search for the first path according to the accumulated symbol to generate a first path signal; and
a first path dynamic range generator coupled to the first path searcher and configured to generate a first path dynamic range (FPDR) according to at least the first path signal;
wherein the preset proportion is less than 1/2.

11. A method of operating a communication device, the method comprising:
amplifying a preset proportion of symbols in a set of input symbols to generate a set of amplified symbols;
accumulating the set of amplified symbols to generate an enhanced symbol, and searching for a first path according to the enhanced symbol;
accumulating unamplified symbols in the set of input symbols to generate n normal symbol, and searching for the first path according to the normal symbol;
generating a first path signal if the first path is found according to the enhanced symbol and/or the normal symbol; and
generating a first path dynamic range (FPDR) according to at least the first path signal.

12. The method of claim 11, wherein generating the first path signal if the first path is found according to the enhanced symbol and/or the normal symbol comprises:
generating the first path signal according to the enhanced symbol if the first path is found according to the enhanced symbol but not the normal symbol.

13. The method of claim 11, wherein generating the first path signal if the first path is found according to the enhanced symbol and/or the normal symbol comprises:
generating the first path signal according to the enhanced symbol if the first path is found according to both the enhanced symbol and the normal symbol.

14. The method of claim 11, wherein generating the first path signal if the first path is found according to the enhanced symbol and/or the normal symbol comprises:
generating the first path signal according to the normal symbol if the first path is found according to the normal symbol but not the enhanced symbol.

15. The method of claim 11, wherein the preset proportion is less than ½.

16. The method of claim 11, wherein generating the first path dynamic range according to at least the first path signal comprises:
generating the first path dynamic range according to the first path signal, a resolution of the analog-to-digital converter, a gain of the set of amplified symbols, and a clipping noise.

17. The method of claim 11, wherein the set of input symbols includes preamble symbols and/or scrambled timestamp sequence (STS) symbols.

18. The method of claim 11, wherein amplifying the preset proportion of symbols in the set of input symbols to generate the set of amplified symbols comprises:
amplifying the preset proportion of consecutive symbols in the set of input symbols to generate the set of amplified symbols.
